(19) United States
(12) Patent Application Publication
(10) Pub. No.: US 2003/0078331 A1
(43) Pub. Date: Apr. 24, 2003

(54) Polyphenyleneoxide-based composite resin composition for ic tray

(76) Inventors: Kwan-Seup Kim, Seoul (KR); Myung-Woo Park, Chungcheong-buk-do (KR)

Correspondence Address: WORKMAN NYDEGGER & SEELEY, 1000 EAGLE GATE TOWER, 60 EAST SOUTH TEMPLE, SALT LAKE CITY, UT, 84111, US

(21) Appl. No.: 10/148,506

(22) PCT Filed: Sep. 27, 2001
(86) PCT No.: PCT/KR01/01625

(30) Foreign Application Priority Data
Oct. 2, 2000 (KR) 2000/58006

(51) Int. Cl. C08K 3/26

(52) U.S. Cl. 524/425; 524/449; 524/451; 524/447

(57) ABSTRACT

The present invention relates to polyphenylene-based composite resin composition for IC TRAY, which comprises polyphenyleneoxide or polyphenylene ether at the amount of 20 to 98 wt % of total composition weight; one or more resins selected from the group consisting of polystylene, polyphenylene sulfide, polyetherimide, polycarbonate and polyethylene (including HDPE, LDPE, LLDPE, VLDPE) at the amount of 1 to 40 wt % of total composition weight; and glass fiber or inorganic fillers at the amount of 1 to 40 wt % of total composition weight. In addition, the composition of the present invention has excellent mechanical strength, dimensional stability, low linear fever expansion coefficient, and a good outlook for a product. The composition of the present invention is appropriate for IC TRAY in view that it does not deflect due to contraction, linear expansion coefficient and heat, thus having excellent dimensional stability.

### TECHNICAL FIELD

The present invention relates to polyphenyleneoxide-based composite resin composition for IC TRAY. In particular, the present invention relates to composite resin composition for IC TRAY that has excellent heat resistance, good quality of a product surface, superior injection molding, and contraction rate and linear expansion coefficient. These factors play an important role in both novel and conventional IC TRAY injection molding in view that excellent dimensional stability, warpage protection and heat resistance are obtained for IC TRAY using polyphenyleneoxide-based composite resin composition.

### BACKGROUND ART

In the past, in order to manufacture an IC TRAY, acrylobutadiene-styrene-copolymer (ABS), polyphenyleneoxide, polyphenylene ether (PRO or PPE), polysulfone or polyethersulfone resin were mixed with carbon fiber or conductive carbon black, and if necessary, other inorganic fillers (i.e., glass fiber, talc, mica, kaolin, or ulastonite etc.) resin for manufacturing injection molding material for an IC TRAY.

Normally, an IC TRAY should have precision of less than 0.1 mm range of error. For example, if the IC TRAY were not precisely manufactured, a semiconductor would not properly be placed or becomes difficult to remove later. Thus, a semiconductor being free of twist but having excellent heat resistance and electricity has been needed.

The conventional IC TRAY manufacturing method used conductive carbon black or carbon fiber at the amount of approximately 15˜35 wt % in order to protect a semiconductor, which served to prevent static on the IC TRAY by malting the IC TRAY conductive.

When the conductive carbon black or carbon fiber was not added, static on IC TRAY causes the gold wire of a semiconductor to be short circuit, which eventually leads the semiconductor to function improperly. From this light, adding conductive carbon black or carbon fiber was very important for IC TRAY manufacture despite of the high cost of adding those materials.

The problem was overcome by developing a new surface treatment technology by applying ion beam, plasma or conductive solution dipping. As the technology gets commercialized, the conductive carbon black or carbon fiber has become no longer needed. Still, another problem remained because heat resistant temperature, contraction rate, warpage and dimensional stability of a semiconductor were not secured without the conductive carbon black or carbon fiber.

Table 1 below illustrates resin(s) which are typically used for an IC TRAY depending on the baking temperature.

TABLE 1

| Baking temperature (° C.) | Resin(s) used |
|---|---|
| 90 | ABS |
| 130 | PPO or PPE |
| 150 | Polysulfone group (PSU) |
| 180 | Polyethersulfone group (PES) |

As shown in Table 1, a different resin is needed depending on the baling temperature of a semiconductor. In addition, only an IC TRAY with superior dimensional stability could be employed for the semiconductor in order to protect the same in a different baking temperature.

Nevertheless, the dimensional stability became noticeably poorer if carbon black or carbon fiber was not added. Moreover, heat resistant temperature was not compatible for baking temperature, and the conventional molding and contraction rate were not matched resulting in the IC TRAY injection molding to be given up or repaired entirely. In either case, it cost a lot of money.

### DISCLOSURE OF INVENTION

In consideration of the problem noted above, the object of the present invention is to provide polyphenyleneoxide -based composite resin composition, giving a low specific gravity, an easy injection molding, dimensional stability, a heat resistance and a contraction rate, thus making the IC TRAY surface smooth through the treatment of ion beam or plasma treatment for manufacturing a novel IC Tray injection mold or using the conventional IC Tray mold in absence of conductive carbon black or carbon fiber.

Another object of the present invention is to provide a polyphenyleneoxide—based composite resin composition furnishing a dimensional stability, a heat resistance, a contraction rate and smooth surface, especially at the temperature of 150° C. at which a relatively expensive semiconductor is normally baked.

The present invention provides a polyphenyleneoxide—based composite resin composition with excellent contraction rate, high linear expansion coefficient, low deflection due to heat, and superior dimensional stability, comprising 20˜98 wt % of polyphenyleneoxide or polyphenylene ether, 1˜40% wt % of one or more resins selected from the group consisting of polystyrene, polyphenylene sulfide, polyetherimide, polycarbonate and polyethelene (including HDPE, LDPE, LLDPE, VLDPE), and 1˜40 wt % of glass fiber or inorganic fillers.

Polyphenyleneoxide—based composite resin composition according to the present invention can further comprise 1˜40 wt % of inorganic supplements, 1˜30 wt % of mica, or 0.1˜15 wt % of other additives. Here, the additives described above can comprise carbon black or pigment.

Besides the qualities described above, polyphenyleneoxide—based composite resin composition of the present invention has excellent low linear fever expansion coefficient and mechanical strength. Thus, a product thereof not only has smooth surface and outside but also susceptible to treatment like ion beam, plasma or conductive solution dipping. The above composition is suitable for both the conventional IC TRAY mold and a novel IC TRAY mold, and it can manufacture polyphenyleneoxide—based composite resin having excellent dimensional stability and heat resistance.

Especially, in the present invention, more than one fillers could be used respectively or hybrid to manufacture an IC TRAY, or without the fillers so that the IC TRAY can be manufactured, yet still having a broad range of heat resistant temperature and excellent dimensional stability.

### BEST MODE FOR CARRYING OUT THE INVENTION

The following are detailed explanations of each component of polyphenyleneoxide—based composite resin composition according to the present invention:

(1) Polyphenyleneoxide or Polyphenylene Ether

In general, polyphenyleneoxide or polyphenylene ether (hereinafter, it is called “polyphenylene ether”) was originally developed in G.E. Plastic Inc. of America. The present invention uses more than two kinds of polyphenylene ether of G.E. Plastic Inc. are used respectively or hybrid. The polyphenylene ether contains less than 10 ppm of copper and less than 2000 ppm of toluene.

For the present invention, it is preferable to use polyphenylene ether having specific viscosity of 0.1-0.4, 0.41-1.0, or more, respectively or hybrid. Here, polyphenylene of high specific viscosity can be used to keep glass fiber, mica and other fillers from being exposed to the surface of the semiconductor. Meanwhile, fluid polyphenylene of low specific viscosity is used to cover the surface of a product during molding so that it prohibits glass fiber, mica and other fillers from hindering surface treatment by ion beam, plasma or conductive solution dipping.

In case the content of glass fiber, mica and other fillerss is relatively low or zero, single polyphenylene ether can be used. However, if the content is high, depending on the content, it is preferable to use more than two kinds of polyphenylene ether or hybrid to prevent glass fiber, mica and other fillers from protruding out of the surface.

(2) Polystyrene (PS), Polyphenylenesulfide (PPS), Polyetherimide (PEI), Polycarbonate (PC), Acrylobutaienestyrene (ABS), Blended Resin of Polycarbonate and Acrylbutaienestyren (PC/ABS), Polybutylene Terephthalate (PBT) and Composite Resins Thereof.

In the present invention, polystyrene is used because when polyphenyleneoxide or polyphenylene ether is singly applied, it malces very difficult for mass production of IC TRAY due to excessive injection pressure therein. Thus, in order to solve this problem, 1 to 40 wt % of polystyrene is employed in the present invention. Besides, polystyrene or polycarbonate was found to have superior injection fluidity to polyphenyleneoxide or polyphenylene ether, so that it successfully aids injection mass production and malces the surface of a product very smooth.

To maximize the effect aforesaid, polystyrene having flow index below 20 and 10 are used respectively or hybrid. In addition, polycarbonate having especially low viscosity is preferable.

Through the present invention, the inventors have discovered that IC TRAY, which is resistant to 200° C. could be developed by using polyphenylenesulfide and polyetherimide. Compared to the existing IC TRAY, of which heat resistant temperature is 80° C., the invention will greatly reduce manufacturing cost.

In addition, by adding acrylobutadienstyrene or blend of acrylobutadienstyrene and polycarbonate, or polybutylterephthalate and composite resins thereof, injection molding is very activated and relatively good dimensional stability can be obtained. Thus, it became possible to manufacture inexpensive polyphenyleneoxide—based composite resin composition for an IC TRAY.

(3) Polyethylene

It is preferable to use polyethylene with flow index below 30. Polyethylene is used for processing supplementary agent and release agent.

(4) Glass Fiber

Glass fiber with less than 20 μm in diameter and 1 inch in length is used. Generally, acicular, fragmental and nodular type glass fiber are used, respectively or hybrid. It helps to raise heat resistant temperature of the IC TRAY and provides dimensional stability. In order to maximize this effect, it is preferable to use a glass fiber having a diameter between 3 μm and 10 μm. In addition, to eliminate directional property of the surface and glass fiber, 0˜30% by weight of milled glass fiber or chopped glass fiber, glass false can be used. When milled glass fiber or chopped glass fiber is applied, it is possible to prevent three-dimension contraction and obtain fine surface of a product.

(5) Mica

It stabilizes three-dimensional contraction and linear fever expansion coefficient. Similar to glass fiber, it plays a very important role for increasing heat resistant temperature, low linear fever expansion coefficient and contraction rate of an IC TRAY. To prevent the IC TRAY from warpage, preferably 30 μm sized mica is employed, and more preferably, between 3 and 30 μm.

(6) Inorganic Supplement

It supports heat resistance, dimensional stability, linear fever expansion coefficient, warpage protection, three-dimensional contraction and other physical properties (i.e., flexibility, stiffness) of an IC TRAY, and is used respectively or hybrid.

In case Ulrastonite, a compound of calcium-meta-sylicate group, is employed, it is preferable that aspect composition ratio thereof is 10 to 19, average diameter of a particle is between 3 and 25 μm acicular form, and it is contained in amount of 0˜30% by weight of total composition.

In the present invention, talc, calcium-carbonate, asbestos, kaolin and carbon fiber can be used as an inorganic supplement. When talc is used, it is preferable to use between 2 and 4 μm fragmental type talc in average size for a particle.

In case of carbon fiber, since it serves as a filler rather than a conductivity supplier, it is possible to use lower grade, reproduced or chapped carbon fiber.

In order to enhance interfacial tension with polymer, it is occasionally recommended to use a product of which surface is chemically treated. Here, the content of inorganic supplement is preferred at the amount of 1˜40% by weight of total composition.

(7) Additives

Appropriate additives are sometimes added, if necessary in the composition according to the invention. Additives can include a coupling agent, primary or secondary anti-oxidants, ultraviolet stabilizer, heat stabilizer, process lubricants and antistatic agents. Further, carbon black, pigments or nucleariating agent can be also added.

The coupling agent is used to enhance adhesive strength between polyphenylene ether, polystyrene or polyethylene and inorganic supplements, and can be aminosilane or aminotitanium. The coupling agent is preferably used to the amount of 0.05˜3% by weight of total composition.

Primary or secondary anti-oxidants and heat stabilizer are used to prevent a possible thermal decomposition of polyphenyleneoxide-based composite resin composition during processing. As for the primary anti-oxidant, conventional phenol compounds are preferred to the amount of 0.01˜1wt % of total composition weight. And, as for the secondary anti-oxidant, conventional amine compounds could be used to the amount of 0.01˜1% by weight of total composition.

As a heat stabilizer, conventional phenol compounds, such as, 2,6-di-t-butyl-4-methylphenol, or conventional amine compounds, such as, diphenyl-p-phenylenediamine can be used to the amount of 0.01˜1.0% by weight of total composition.

An ulraviolet stabilizer can be used for supporting weather resistance of the composite resin and for preventing decomposition of the same due to ultraviolet during outdoor exposure. As the ultraviolet stabilizer, HALS compounds, benzo-phenol compounds, or benzotriazol compounds can be used to the amount of 0.02˜1.0% by weight of total composition.

Process lubricants are used to enhance processing of the composite resin composition, or minimize internal stress remaining in the resin so that IC TRAY injection flow can be done smoothly. As for the process lubricants, Ca-Stearate, Zn-sterate, Zn-Oxide, Alicyclic saturated hydrocarbon resin is used to the amount of 0.05˜15% by weight of total composition weight. Especially, it is more preferable to use 0.1˜15% by weight of alicyclic saturated hydrocarbon resin.

Anti-static agents are used to keep dusts or other alien substances off from IC TRAY while manufacturing or moving the same. Typically used anti-static agents are alkylamine compounds or stearic acid compounds, and 0.01˜1.0% by weight of allylamine compounds.

If necessary, carbon black, pigments or nucleariating agent can be added for increasing color manifestation and weather resistance. The preferred content of the additives is 0.05 to 1 wt % of total composition weight.

In the present invention, Henssel Blender, Robbon Blender or V-Blender is used to mix the materials necessary to manufacture a polyphenylene—based composite resin composition for an IC TRAY according to the invention. Also, a different material from different material suppliers can be directly applied to the processing device at a specific ratio. Here, depending on material and final composition properties, 1-axle extruder, 2-axle extruder, Kneader Mixer, or Banbery Mixer is used as the processing device. Using the processing device, the components of resin composition of the invention are dissolved and mixed together, and then made into the shape of pellet. At this point, the physical properties and capacities of the resin composition may be altered depending on the process conditions, 2-axle extruder, which provides an extra supplier besides the existing supplier, is preferably used because it can modify rotational frequency of a screw, extruding amount, and process temperature to choose the optimum process conditions for manufacturing the composite resin composition.

After the composite resin composition goes through a regular process to eliminate moisture and volatile matter from the composite resin composition, it is manufactured as injection or extrusion section. By America Standard Measurement, the mechanical and thermal physical properties of the composition are measured. Then, contraction rate, heat resistance and contraction due to heat are measured for the manufactured IC TRAY.

For better understanding of the embodiment of the present invention, the following examples are provided, but the invention is not limited to the examples below.

Table 2 shows that polyphenyleneoxide-based composite resin composition is dissolved using the secondary extruder and manufactures as pellet type. Following that, IC TRAY is injected from an injector with more than 150 tons of formability in order to find out contraction rate and dimensional stability, and heat stability and dimensional stability at a certain balking temperature of a semiconductor.

TABLE 2

| | Example 1 | Example 2 | Example 3 | Example 4 | Example 5 | Example 6 |
|---|---|---|---|---|---|---|
| A1 | 37 | 36 | 36 | 41.25 | 43.5 | 40 |
| A2 | 30 | 30 | 20 | 20 | | 22 |
| B1 | 18 | 4 | 6 | 7.5 | | 6 |
| B2 | | 4 | 4 | | | 6 |
| C1 | 0.5 | 0.25 | | 0.25 | | 0.5 |
| C2 | | 0.25 | | | | |
| D1 | 14.5 | 14.4 | 24.5 | 35 | 0.25 | 9.5 |
| D2 | | 10 | 8 | | | |
| D3 | | | | 15 | 15 | 5 |
| D4 | | | | | | 5 |
| D5 | | | | | | 5 |
| F1 | | | 0.5 | | 6 | |
| Additives | 1 | 1 | 1 | 1 | | 1 |

In the above Table 2, each component is indicated A to F, and more specific properties of the component are shown in Table 3 and Table 4. In Table 2, A1 and A2 indicate components of polyphenylene ether or polyphenyleneoxide and each specific viscosity are shown in Table 3. B1 and B2, content of polystyrene and flow index thereof, are shown in Table 4. C2 and C2 are polyethylene, C1 being the content of a low flow index polyethylene and C2 being the content of a high flow index polythylene F1 indicates alicyclic saturated hydrocarbon resin.

Table 4 shows respecting D1 to D5.

Table 5 shows different additives.

TABLE 3

| Physical | | | | | | | |
|---|---|---|---|---|---|---|---|
| property | A1 | A2 | B1 | B2 | C1 | C2 | F1 |
| Specific | 0.33 | 0.4 | | | | | |
| viscosity | | | | | | | |
| Fusion | | | 5.5 | 9 | 10 | 3 | |
| index | | | | | | | |
| Average | | | | | | | 1235 |
| Molecular | | | | | | | |
| weight | | | | | | | |

TABLE 4

| | D1 | D2 | D3 | D4 | D5 |
|---|---|---|---|---|---|
| | Glass fiber | Glass fiber | Mica | Talc | Ulastonite |
| Form | acicula | nodula | fragment | fragment | acicula |
| Average | 3 | 3 | 3 | 3 | 8 |
| Diameter | | | | | |
| (μm) | | | | | |

TABLE 5

| Additives | Chemical Name | Content (wt %) |
|---|---|---|
| Process Lubricants | Ca-stearate, Zn-stearate, Zn- | 0.1 |
| | Oxide, or Alicyclic | |
| | saturated hydrocarbon resin | |
| Primary Anti-Oxidants | Tetrakis(methylene(3,5-di- | 0.2 |
| | tetra-butyl-4-hydroxy- | |
| | hydroxynamate))methane | |
| Secondary Anti-Oxidants | Tris(2,4-di-tetra- | 0.1 |
| | buthylphenyl)phosphate | |
| Antistatic Agents | Alkylamines | 0.1 |
| Ultraviolet Stabilizer | HALS, Benzophenol or | |
| | Benxo triazol compounds | |
| Coupling Agent | Aminosilane or Aminotitan | |
| Carbon Black | | 0.5 |

Table 6 shows final dimensional stability and warpage after IC TRAY injection. Here, the name of IC TRAY employed in the composition of the invention is

TABLE 6

| Measurement | Size | Example 1 | Example 2 | Example 3 | Example 4 | Example 5 | Example 6 |
|---|---|---|---|---|---|---|---|
| X-axis | 315.00 | 315.04 | 314.88 | 315.00 | 315.12 | 315.00 | 314.95 |
| (pre-baking) | ± 0.30 | | | | | | |
| X-axis | 315.00 | 314.94 | 314.73 | 314.88 | 314.99 | 315.01 | 314.82 |
| (post- | ± 0.30 | | | | | | |
| baking) | | | | | | | |
| Y-axis | 135.90 | 135.99 | 135.77 | 135.79 | 135.92 | 136.12 | 135.83 |
| (pre-baking) | ± 0.30 | | | | | | |
| Y-axis | 135.90 | 135.93 | 135.70 | 135.71 | 135.85 | 135.97 | 135.77 |
| (post- | ± 0.30 | | | | | | |
| baking) | | | | | | | |
| Thickness | 7.62 ± | 7.66 | 7.63 | 7.64 | 7.63 | 7.67 | 7.63 |
| (pre-baking) | 0.10 | | | | | | |
| Length | 322.60 | 322.54 | 322.51 | 322.60 | 322.80 | 322.79 | 322.56 |
| (pre-baking) | ± 0.30 | | | | | | |
| Length | 322.60 | 322.41 | 322.34 | 322.43 | 322.61 | 322.62 | 322.38 |
| (post- | ± 0.30 | | | | | | |
| baking) | | | | | | | |
| Warpage | Below | 0.16 | 0.17 | 0.25 | 0.12 | 0.13 | 0.07 |
| (pre-baking) | 0.76 | | | | | | |
| Warpage | Below | 0.19 | 0.12 | 0.48 | 0.15 | 0.16 | 0.06 |
| (post- | 0.76 | | | | | | |
| baking) | | | | | | | |

As shown in Table 6, polyphenylene-based composite resin composition for IC TRAY of the present invention satisfied JEDEC standards of dimensional stability after injection and post-baling under ion beam, plasma treatment or conductive solution dipping treatment.

In addition, the composition satisfied the standards for IC TRAY impact test, which is measured by examining damage when, for example, 20 IC TRAYs were fallen from 30 to 50 cm high, after injection or post-baking.

In conclusion, polyphenylene-based composite resin composition of the present invention has excellent contraction rate, dimensional stability, linear fever expansion coefficient and heat resistance. Moreover, it showed superior physical properties, such as mechanical strength or impact resistance. The much improved injection molding makes the surface of a product smooth, malting possible to produce a product appropriate for IC TRAY in the treatments like ion beam, plasma or conductive solution dipping. In the present invention, various kinds of resins and additives are applied respectively or hybrid so that it was possible to manufacture an appropriate IC TRAY for the conventional IC TRAY molding. Also, while manufacturing a novel molding, an IC TRAY of low density was successfully manufactured, which greatly reduced manufacture expenses by substituting raw material for an expensive IC TRAY containing carbon fiber or conductive carbon black.

The foregoing discussion of the invention has been presented for purposes of illustration and description. The foregoing is not intended to limit the invention to the form or forms disclosed herein. Although the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

1. A polyphenylene-based composite resin composition, comprising polyphenyleneoxide or polyphenylene ether at the amount of 20 to 98 wt % of total composition weight; one or more resins selected from the group consisting of polystylene, polyphenylene sulfide, polyetherimide, polycarbonate and polyethylene (including HDPE, LDPE, LLDPE, VLDPE) at the amount of 1 to 40% by weight; and glass fiber or inorganic fillers at the amount of 1 to 40% by weight.

2. The composition according to claim 1, wherein the inorganic fillers is glass fiber.

3. The composition according to claim 1, which further comprises 1˜30% by weight of mica.

4. The composition according to either claim 1 or claim 3, which further comprises 1˜15% by weight of additive.

5. The composition according to claim 4, wherein the additive is carbon black or pigments.

6. The composition according to claim 1, wherein the resin is used respectively or hybrid having the specific viscosity from 0.1˜0.4, 0.41˜1.0, and more.

7. The composition according to claim 1, wherein polystyrene resin employs polystyrene of flow index below 20 and polystyrene of flow index below 10, respectively or hybrid.

8. The composition according to claim 1, wherein flow index of polyethylene resin is below 30.

9. The composition according to claim 1, wherein the glass fiber is of a diameter below 20 μm and a length below 1 inch is employed in a form of acicula, fragment or nodula, respectively or hybrid.

10. The composition according to claim 1, wherein instead of the glass fiber, milled glass fiber, chopped glass fiber or glass flake is employed, respectively or hybrid.

11. The composition according to claim 3, wherein the mica is below 30 μm in size.

12. The composition according to claim 1, which further comprises an inorganic supplement.

13. The composition according to claim 12, wherein as the inorganic supplement, Talc, Calcium-carbonate, Asbestos, Kaolin, Calcium-meta-silicate ulastonite, or carbon fiber is employed, respectively or hybrid.

14. The composition according to claim 13, wherein the Ulrastonite's aspect composition ratio is 10 to 19 and the average diameter of a particle is 3 to 25 μm of acicula.

15. The composition according to claim 13, wherein the average size of a particle for the Talc is 2 to 4 μm of fragment.

16. The composition according to claim 4, wherein the additive employs the following, respectively or hybrid:
a primary anti-oxidant, comprising 0.01˜1.0% by weight of phenol or 0.01˜1.0% by weight of amine;
a HALS ultraviolet stabilizer, comprising 0.02˜1.0% of the same by weight;
a process lubricants, comprising 0.05˜15% by weigh;
a coupling agent, comprising 0.05˜3.0% by weight of amino silane or amino titanium; and
an anti-static agent from alkylamine group, comprising 0.01˜1.0% by weight.

17. The composition according to claim 13, wherein the process lubricants comprising 0.1˜15% by weight of alicyclic saturated hydrocarbon resin.

18. An IC TRAY, which is obtained by using a polyethyleneoxide-based composite resin composition comprising:
20˜98% by weight of polyphenyleneoxide or polyphenylene ether;
1˜40% by weight of one or more resins selected from the group consisting of polystylene, polyphenylene sulfide, polyetherimide, polycarbonate and polyethylene (including HDPE, LDPE, LLDPE, VLDPE); and 1˜40% by weight of glass fiber or inorganic filler.
